(19) United States
(12) Patent Application Publication
(10) Pub. No.: US 2025/0037913 A1
(43) Pub. Date: Jan. 30, 2025

(54) ASSEMBLED INDUCTOR

(71) Applicant: Zenith Tek Inc., New Taipei (TW)

(72) Inventor: Mark Huang, New Taipei (TW)

(21) Appl. No.: 18/243,127

(22) Filed: Sep. 7, 2023

(30) Foreign Application Priority Data
Jul. 27, 2023 (TW) 112128130

(51) Int. Cl. H01F 3/14; H01F 27/08; H01F 27/10

(52) U.S. Cl. CPC H01F 3/14; H01F 27/085; H01F 27/10

(57) ABSTRACT

An assembled inductor includes a first magnetic core; a second magnetic core; a metal member disposed between the first magnetic core and the second metal member; and a plurality of gaps formed among the first magnetic core, the second magnetic, and the metal member. Further, the first magnetic core includes a plurality of inner projections. Furthermore, there is provided a second metal member disposed in the metal member.

### FIELD OF THE INVENTION

The invention relates to inductors and more particularly to an assembled inductor including gaps for allowing a fluid medium (e.g., air or a liquid coolant) to pass through, thereby increasing heat transfer performance.

### BACKGROUND OF THE INVENTION

An inductor is a passive two-terminal electrical component that stores energy in a magnetic field when electric current flows through it. Conventionally, an inductor consists of an insulated wire wound into a coil. When the electric current flowing through the coil changes, the time-varying magnetic field induces an electromotive force (voltage) in the conductor.

Many inductors have a magnetic core made of iron or ferrite inside the coil, which serves to increase the magnetic field and thus the inductance. Inductors are used to block AC while allowing DC to pass. Inductors are also used in electronic filters to separate signals of different frequencies.

The core of an inductor can be classified as EE core, EI core and HI core in terms of shape. The inductors having EE and EI cores can be further classified as flat pack inductor and TLVR inductor.

The conventional inductor includes a metal frame and a magnetic core fastened together by adhesive. However, heat can only be dissipated through surfaces. Energy dissipation by a fluid medium (e.g., air or a liquid coolant) is not disclosed by the conventional inductor.

Thus, the need for improvement still exists.

### SUMMARY OF THE INVENTION

It is therefore one object of the invention to provide assembled inductor comprising a first magnetic core; a second magnetic core; a metal member disposed between the first magnetic core and the second metal member; and a plurality of gaps formed among the first magnetic core, the second magnetic, and the metal member.

Preferably, the first magnetic core includes a plurality of inner projections.

Preferably, there is further provided a second metal member disposed in the metal member.

The above and other objects, features and advantages of the invention will become apparent from the following detailed description taken with the accompanying drawings

### BRIEF DESCRIPTION OF THE DRAWINGS

FIG. 1 is an exploded view of an EE type assembled inductor according to the invention;

FIG. 2 is a perspective view of the EE type assembled inductor;

FIG. 3 is an exploded view of an EI type assembled inductor according to the invention;

FIG. 4 is a perspective view of the EI type assembled inductor;

FIG. 5 is an exploded, perspective view of a first preferred embodiment of the EE type assembled inductor according to the invention;

FIG. 6 is a perspective view of the first preferred embodiment of the EE type assembled inductor;

FIG. 7 is an exploded, perspective view of a second preferred embodiment of the EE type assembled inductor according to the invention;

FIG. 8 is a perspective view of the second preferred embodiment of the EE type assembled inductor;

FIG. 9 is an exploded view of a third preferred embodiment of the EE type assembled dual coils inductor according to the invention;

FIG. 10 is an exploded, perspective view of a fourth preferred embodiment of the EE type assembled dual coils inductor according to the invention;

FIG. 11 is an exploded, perspective view of a fifth preferred embodiment of the EE type assembled inductor according to the invention;

FIG. 12 is an exploded of a HI type assembled inductor according to the invention;

FIG. 13 is a perspective view of the HI type assembled inductor;

FIG. 14 is an exploded view of a first preferred embodiment of the HI type assembled inductor according to the invention;

FIG. 15 is a perspective view of the first preferred embodiment of the HI type assembled inductor;

FIG. 16 is an exploded view of a second preferred embodiment of the HI type assembled inductor according to the invention; and

FIG. 17 is a perspective view of the second preferred embodiment of the HI type assembled inductor.

### DETAILED DESCRIPTION OF THE INVENTION

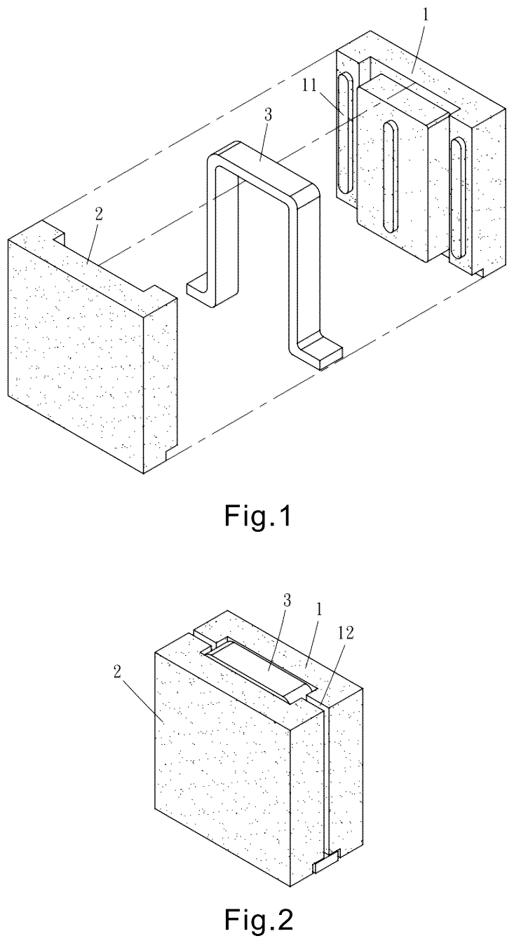

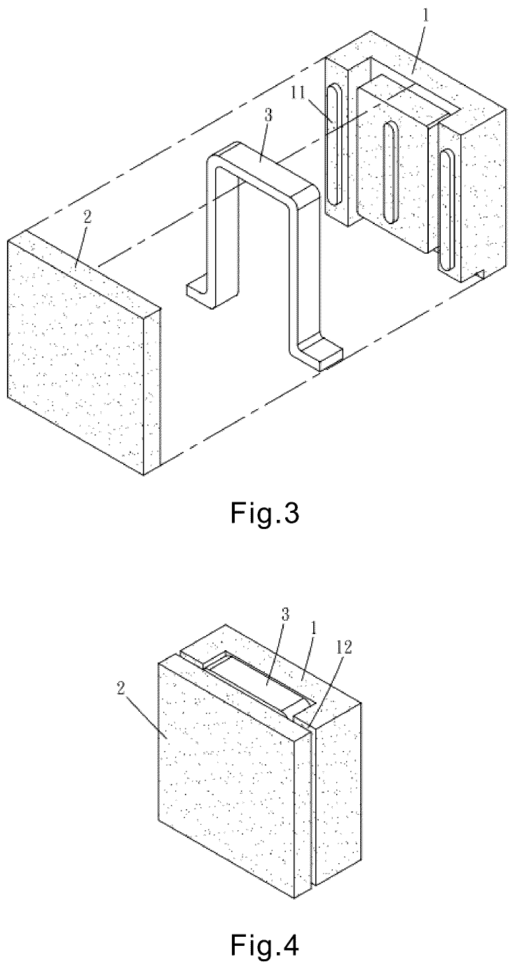

Referring to FIGS. 1 to 2, an EE type assembled inductor according to the invention comprises a first magnetic core 1 having a right square bracket section and including three inner projections 11, a second magnetic core 2 having a left square bracket section, and an inverted U-shaped metal member 3 disposed between the first magnetic core 1 and the second magnetic core 2. Plural gaps 12 each are formed between first sides of the first magnetic core 1 and the second magnetic core 2 or between second sides of the first magnetic core 1 and the second magnetic core 2 due to the provisions of the projections 11. Thus, a fluid medium (e.g., air or a liquid coolant) may pass through the gaps 12.

Referring to FIGS. 3 to 4, an EI type assembled inductor according to the invention comprises a first magnetic core 1 having a right square bracket section and including three inner projections 11, a second magnetic core 2 having a rectangular section, and an inverted U-shaped metal member 3 disposed between the first magnetic core 1 and the second magnetic core 2. Multi gaps 12 each are formed between first sides of the first magnetic core 1 and the second magnetic core 2 or between second sides of the first magnetic core 1 and the second magnetic core 2 due to the provisions of the projections 11. Thus, a fluid medium (e.g., air or a liquid coolant) may pass through the gaps 12.

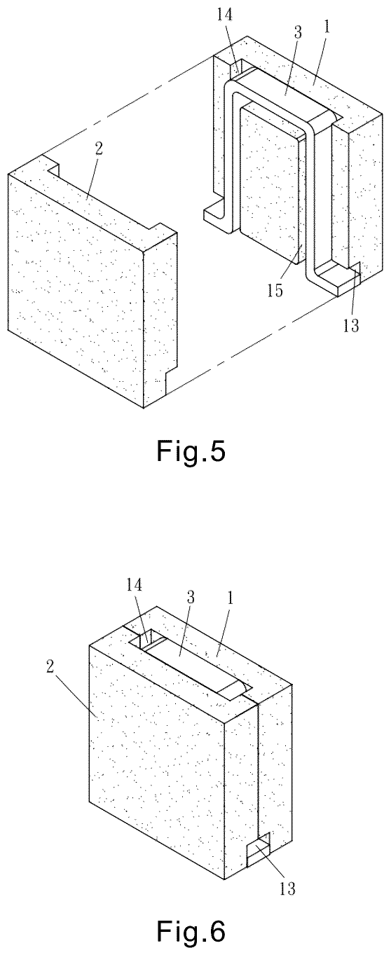

Referring to FIGS. 5 to 6, a first preferred embodiment of the EE type assembled inductor according to the invention is characterized by having gaps 13, 14 and 15 formed among the first magnetic core 1, the second magnetic core 2 and the metal member 3. Thus, a fluid medium (e.g., air or a liquid coolant) may pass through the gaps 13, 14 and 15.

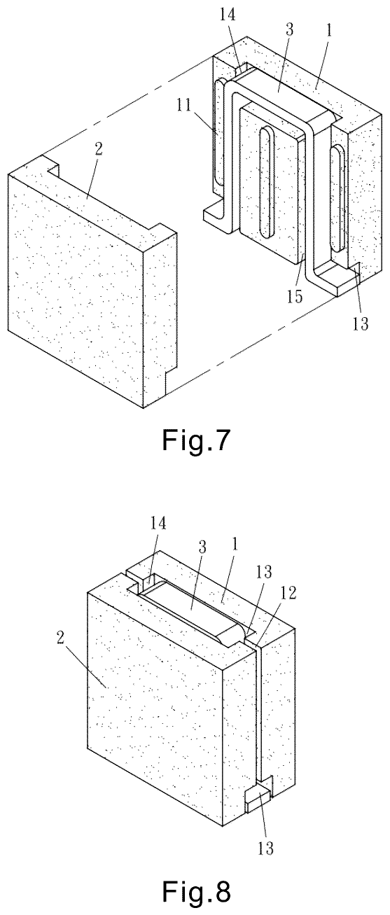

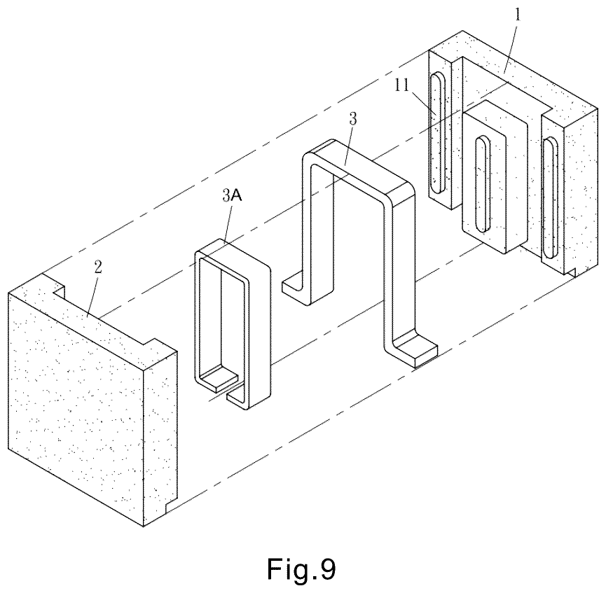

Referring to FIGS. 7 to 8, a second preferred embodiment of the EE type assembled inductor according to the invention is characterized by the first magnetic core 1 including three inner projections 11 and having gaps 12, 13, 14 and 15 formed among the first magnetic core 1, the second magnetic core 2 and the metal member 3. Thus, a fluid medium (e.g., air or a liquid coolant) may pass through the gaps 12,13, 14 and 15.

Referring to FIG. 9, a third preferred embodiment of the EE type assembled inductor according to the invention is characterized by further comprising an inverted U-shaped second metal member 3A disposed in the inverted U-shaped metal member 3 and the first magnetic core 1 including three inner projections 11. Thus, a fluid medium (e.g., air or a liquid coolant) may pass through gaps (not shown) among the first magnetic core 1, the second magnetic core 2, the metal member 3, and the second metal member 3A.

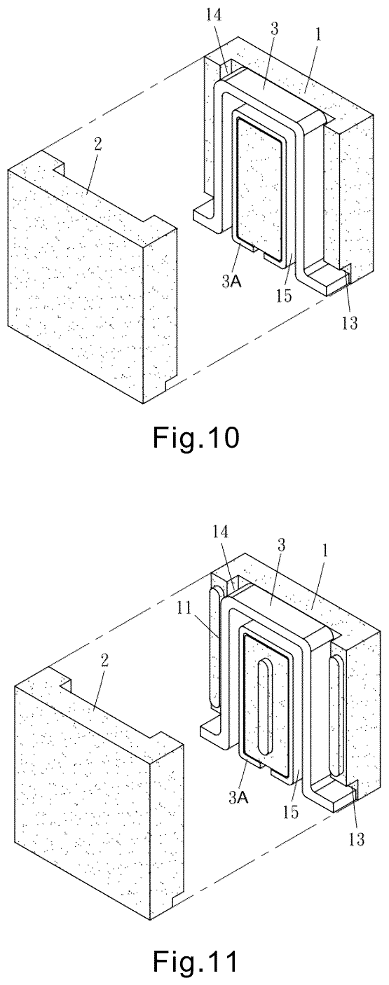

Referring to FIG. 10, a fourth preferred embodiment of the EE type assembled inductor according to the invention is characterized by further comprising an inverted U-shaped second metal member 3A disposed in the inverted U-shaped metal member 3. Thus, a fluid medium (e.g., air or a liquid coolant) may pass through gaps 13, 14 and 15 among the first magnetic core 1, the second magnetic core 2, the metal member 3, and the second metal member 3A.

Referring to FIG. 11, a fifth preferred embodiment of the EE type assembled inductor according to the invention is characterized by further comprising an inverted U-shaped second metal member 3A disposed in the inverted U-shaped metal member 3 and the first magnetic core 1 including three inner projections 11. Thus, a fluid medium (e.g., air or a liquid coolant) may pass through gaps 13, 14 and 15 among the first magnetic core 1, the second magnetic core 2, the metal member 3, and the second metal member 3A.

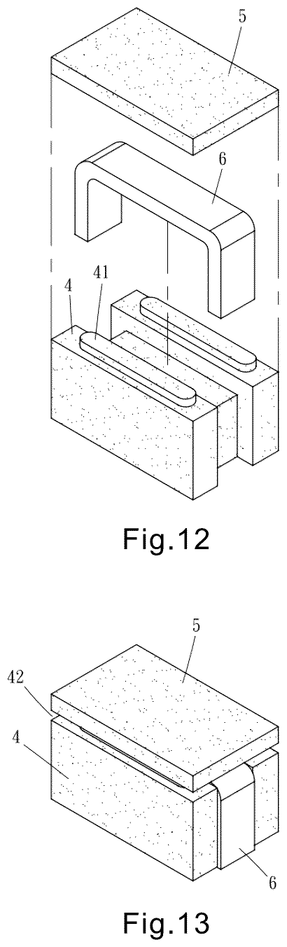

Referring to FIGS. 12 to 13, a HI type assembled inductor according to the invention comprises a third magnetic core 4 and including two inner projections 41, a fourth magnetic core 5, and an inverted U-shaped third metal member 6 disposed between the third magnetic core 4 and the fourth magnetic core 5. A gap 42 is formed among the third magnetic core 4, the fourth magnetic core 5 and the third metal member 6. Thus, a fluid medium (e.g., air or a liquid coolant) may pass through the gap 42.

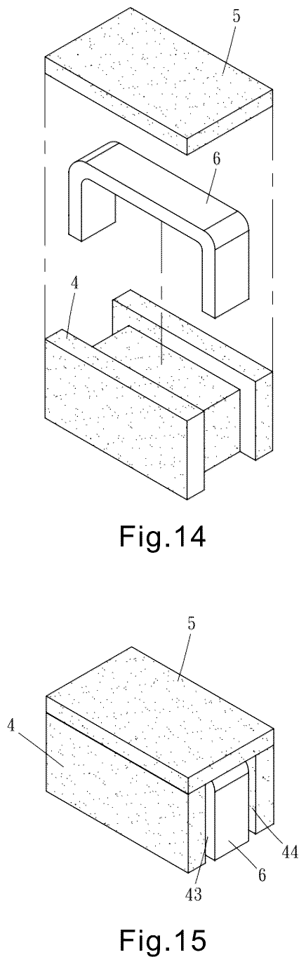

Referring to FIGS. 14 to 15, a first preferred embodiment of the HI type assembled inductor according to the invention is characterized by removing projections and forming plural gaps 43 and 44 among the third magnetic core 4, the fourth magnetic core 5, and the third metal member 6. Thus, a fluid medium (e.g., air or a liquid coolant) may pass through the gaps 43 and 44.

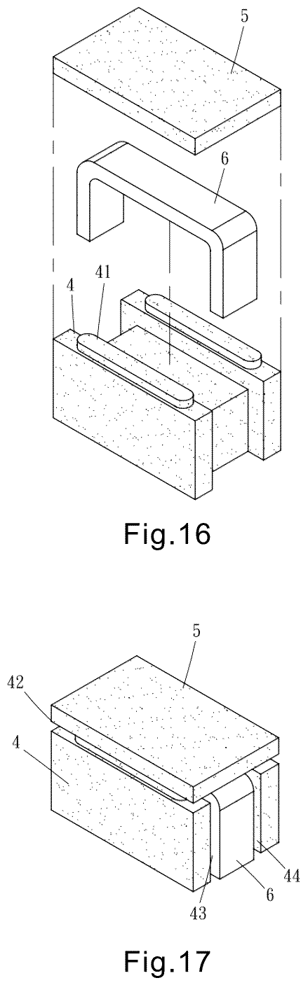

Referring to FIGS. 16 to 17, a second preferred embodiment of the HI type assembled inductor according to the invention is characterized by comprising a third magnetic core 4 and including two inner projections 41, a fourth magnetic core 5, and an inverted U-shaped third metal member 6 disposed between the third magnetic core 4 and the fourth magnetic core 5. Gaps 42, 43, and 44 are formed among the third magnetic core 4, the fourth magnetic core 5 and the third metal member 6. Thus, a fluid medium (e.g., air or a liquid coolant) may pass through the gaps 42, 43, and 44.

While the invention has been described in terms of preferred embodiments, those skilled in the art will recognize that the invention can be practiced with modifications within the spirit and scope of the appended claim.

What is claimed is:

1. An assembled inductor, comprising:
a first magnetic core;
a second magnetic core;
a metal member disposed between the first magnetic core and the second metal member, and
a plurality of gaps formed among the first magnetic core, the second magnetic, and the metal member.

2. The assembled inductor of claim 1, wherein the first magnetic core includes a plurality of inner projections facing the second magnetic core.

3. The assembled inductor of claim 1, further comprising a second metal member disposed in the metal member.
